(19) United States
(12) Patent Application Publication
(10) Pub. No.: US 2012/0201406 A1
(43) Pub. Date: Aug. 9, 2012

(54) EARPHONE

(76) Inventor: Fumihiko Yamaguchi, Tokyo (JP)

(21) Appl. No.: 13/500,201

(22) PCT Filed: Mar. 18, 2010
(86) PCT No.: PCT/JP2010/054662

§ 371 Date: Apr. 4, 2012

(30) Foreign Application Priority Data
Oct. 5, 2009 (JP) 2009-231916

(51) Int. Cl. H04R 5/033

(52) U.S. Cl. 381/309

(57) ABSTRACT

an earphone has a driver unit that generates a sound according to an electrical signal inputted therein, a first sound channel from which the sound generated in the driver unit is outputted, and a second sound channel through which a sound generated in the driver unit is transmitted by way of a channel different from the first sound channel to combine the transmitted sound with the sound in the first sound channel.

### BACKGROUND OF THE INVENTION

1. Field of the Invention

The present invention relates to a stereo earphone and to a technique of solving a problem that in-head sound localization gives awkwardness and uncomfortable feelings.

2. Description of Related Art

an earphone is configured to generate a sound corresponding to an input signal by generating a compression wave of air using vibrations of a vibration plate in a driver unit installed in a housing. In particular, an insert-type earphone, which directly transmits sounds to the entrance of an external auditory canal by a sound conduit and an ear piece, is advantageous in that efficiency is high and influences of external sounds are small.

With the earphone as above, however, the lack of out-of-head sound localization becomes a problem. More specifically, because sound images are not localized outside the head of a listener but localized in the head of the listener, there arises a problem that the listener perceives sounds as if the sounds were coming from within the head and feels awkward or has uncomfortable feelings.

The reason for this problem is thought to be chiefly the lack of information on transfer functions (reflection and reverberation) of indoor and outdoor spaces, on the basis of which information a sense of sound direction is perceived, and a variance of an acoustic transfer function in the external auditory canal caused by connecting the earphone directly to the external auditory canal.

A sense of sound direction can be obtained on the basis of a difference of sound pressure levels and a phase difference between the both ears and information on reflected sounds. In particular, listening through an earphone lacks information on reflected sounds. On the other hand, an occlusion effect in an external auditory canal is exerted by connecting an earphone directly to the external auditory canal. In other words, when sounds are listened to with the entrance of the external auditory canal closed, a resonance property of the external auditory canal as a tube varies.

For example, when an individual listens to a sound S, the external auditory canal Ex normally functions as a resonant tube opening at one end and closing at the other end, assuming that, as is shown in FIG. 3A, the entrance of the external auditory canal is an opening end OE and the ear drum ED is a closing end CE. In this case, a resonant frequency of the external auditory canal has a frequency characteristic that peaks in the vicinity of 3 kHz.

However, when an individual wearing an earphone listens to a sound S1, the external auditory canal Ex functions as a resonant tube closing at the both ends, assuming that, as is shown in FIG. 3B, the entrance of the external auditory canal is a closing end CE and the ear drum ED is also a closing end CE. Accordingly, the resonant frequency characteristic of the external auditory canal Ex varies and no longer peaks in the vicinity of 3 kHz and turns to a frequency characteristic that instead peaks in the vicinity of 6 kHz.

These reasons unique to a case where an individual wearing an earphone listens to the sound S1 raise a problem that sound images are not localized outside the head but localized in the head when an individual wears an earphone and the individual feels as if sounds were coming from within the head.

In order to overcome such a problem of the in-head sound localization, various proposals have been made in Patent Documents as follows.

Relevant techniques are disclosed, for example, in JP-A-05-252598, JP-A-09-198056, and JP-A-2008-177798.

### SUMMARY OF THE INVENTION

In the respective Patent Documents above, a digital signal processing circuit is provided and various types of sound signal processing are performed to eliminate the occlusion effect in an external auditory canal or to achieve the out-of-head sound localization when an earphone is used.

When such a digital signal processing circuit is used, it is difficult to incorporate the digital signal processing circuit into an earphone and it becomes necessary to separately provide an apparatus, such as an exclusive-use headphone amplifier.

Accordingly, there arise other problems that it is tedious to find a place to install the signal processing circuit and prepare a power supply and that the signal processing circuit lacks versatility. There is still another problem that even digital processing cannot completely suppress deterioration during signal processing.

The invention was devised to solve the problems as above and has an object to achieve the out-of-head sound localization by an earphone alone without requiring a signal processing circuit.

an earphone according to one aspect of the invention achieving the object as above has a driver unit that converts an electrical signal inputted therein to a sound, a first sound channel through which a sound generated in the driver unit on a sound releasing side in front of the driver unit is introduced into an external auditory canal, and a second sound channel through which a sound generated in the driver unit is transmitted by way of a channel different from the first sound channel to combine the transmitted sound with the sound in the first sound channel.

Herein, the second sound channel is where a sound equivalent to a reflected sound generated by reflection on a spatial boundary is generated.

Also, the second sound channel is provided with an attenuation material that adjusts a phase to match an arrival time difference of the reflected sound generated by reflection on the spatial boundary.

Also, the second sound channel is provided with an attenuation material that makes an adjustment to match a sound pressure level of the reflected sound generated by reflection on the spatial boundary.

Also, the first sound channel is provided with an attenuation material having an attenuation characteristic selected so as to eliminate a variance of a frequency characteristic caused by an occlusion effect in an external auditory canal.

Also, a plurality of opening portions each corresponding to an opening end are provided to the driver unit in each of a front surface and a rear surface to eliminate a variance of the frequency characteristic caused by the occlusion effect in an external auditory canal.

Also, the opening portion is provided with an attenuation material having an attenuation characteristic selected so as to eliminate a variance of the frequency characteristic caused by the occlusion effect in an external auditory canal.

According to the earphone as above, when a sound generated in the driver unit is outputted toward the external auditory canal from the first sound channel as a direct sound, a sound in a delayed state, which is a sound generated in the driver unit and transmitted through the second sound channel as a channel different from the first sound channel, is combined with the direct sound in the first sound channel.

Accordingly, a sound is outputted in a state where a delayed sound is added to the direct sound from the driver unit.

By providing the second sound channel with an attenuation material that makes an adjustment to match a phase delay and a sound pressure level of a reflected sound generated by reflection on the spatial boundary, it becomes possible to generate a sound equivalent to a spatial reflected sound in a suitable phase at a suitable sound pressure level.

Consequently, it becomes possible to achieve the out-of-head sound localization by perceiving a sense of direction within a space by the earphone alone without requiring a signal processing circuit.

Also, by making an adjustment in such a manner that a variance of the frequency characteristic caused by the occlusion effect in an external auditory canal is eliminated by providing an attenuation material to the first sound channel, it becomes possible to achieve the out-of-head sound localization by suppressing the occlusion effect in an external auditory canal by the earphone alone without requiring a signal processing circuit.

Also, by providing a plurality of opening portions each corresponding to an opening end to the driver unit in each of the front surface and the rear surface to eliminate a variance of the frequency characteristic caused by the occlusion effect in an external auditory canal, it becomes possible to achieve the out-of-head sound localization by suppressing the occlusion effect in an external auditory canal by the earphone alone without requiring a signal processing circuit.

Also, by making an adjustment in such a manner that a variance of the frequency characteristic caused by the occlusion effect in an external auditory canal is eliminated by providing an attenuation material having a selected attenuation characteristic to the opening portion, it becomes possible to achieve the out-of-head sound localization by suppressing the occlusion effect in an external auditory canal by the earphone alone without requiring a signal processing circuit.

### BRIEF DESCRIPTION OF THE DRAWINGS

FIG. 1 is a view showing a configuration of an earphone according to an embodiment of the invention.

FIG. 2 is a block diagram of the earphone according to an embodiment of the invention.

FIG. 3A to 3C are view used to describe a manner in which an occlusion effect in an external auditory canal is exerted.

### DESCRIPTION OF THE PREFERRED EMBODIMENTS

Hereinafter, an embodiment to implement the invention will be described in detail with reference to the drawings.

### Configuration of Embodiment

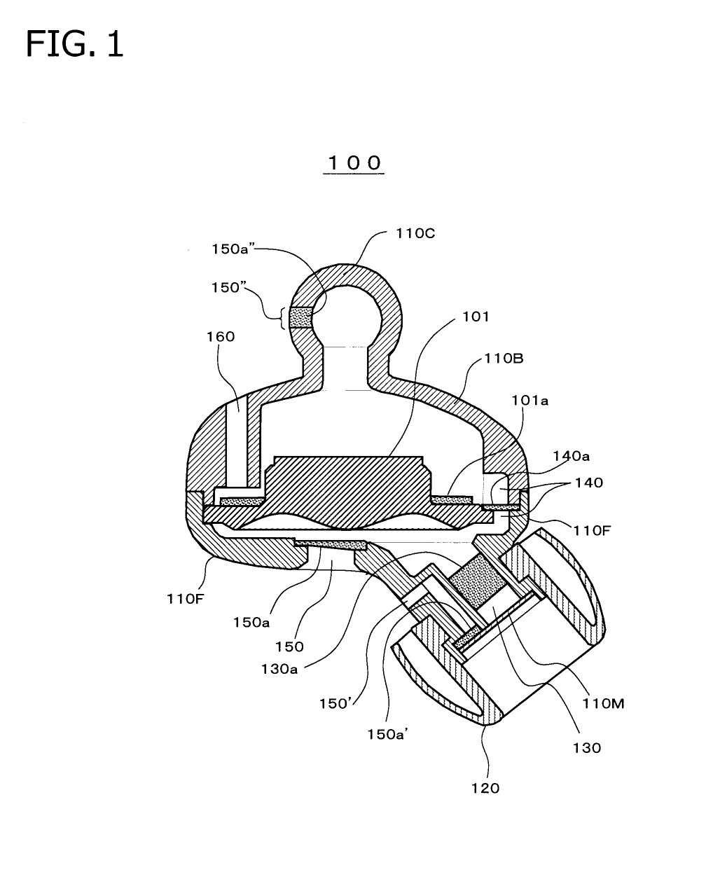

FIG. 1 is a view showing a sectional configuration of an earphone 100 according to an embodiment of the invention.

Referring to FIG. 1, a driver unit 101 that generates a sound by vibrating a vibration plate according to an electric signal inputted therein is installed at a center, and installed on the outside of the driver unit 101 are a front housing 110F as a first sound channel provided as a sound exit and a front enclosure, a back housing 110B provided as a rear enclosure while securing a rear space, and a cable housing 110C provided to secure a rear space and for extraction of cables. Also, an attenuation material 101a is installed on the rear side of the vibration plate of the driver unit 101 to attenuate a resonance peak of the vibration plate.

The front housing 110F is provided with a tube-like first sound channel 130 as a sound exit. Further, an ear piece 120 made of silicon rubber or the like so as to be inserted into the entrance of the external auditory canal is attached to the first sound channel 130 on the outside in the vicinity of the tip end. A mesh 110M preventing entrance of foreign matter is provided to the first sound channel 130 in the vicinity of the tip end. Also, an attenuation material 130a having an attenuation characteristic described below is provided to the first sound channel 130 in the vicinity of a midpoint.

Further, a second sound channel 140 is provided as a reflection component generating sound channel to allow a part of a sound behind the driver unit 101 to be in a state provided with a predetermined time lag as a spatial reflected sound (for example, reflected sound or reverberating sound) and then combined with a sound (direct sound) passing through the first sound channel 130. The second sound channel 140 is provided with an attenuation material 140a to adjust a phase and a sound pressure level of a reflected sound.

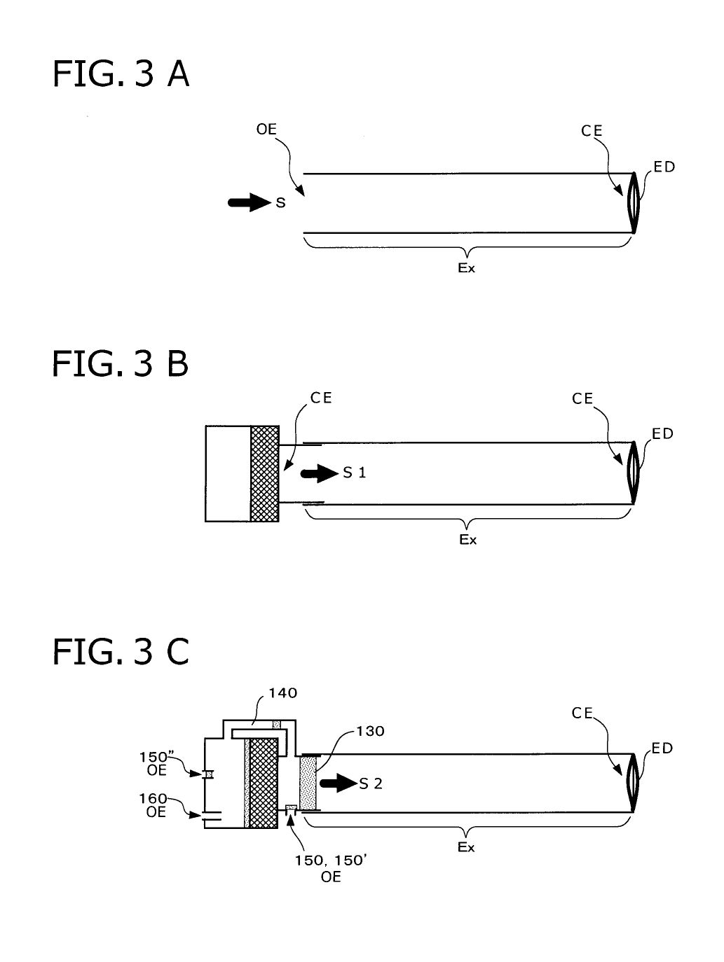

Also, it is configured in such a manner that an opening portion 150 corresponding to an opening end is provided to the front housing 110F in a part at a given position, so that the external auditory canal forms an opening end OE (see FIG. 3C) by preventing the external auditory canal from forming a closing end CE (see FIG. 3B) with the earphone 100. It should be noted that the opening portion 150 corresponding to the opening end is provided with an attenuation material 150a to attenuate a predetermined frequency range, adjust a sound pressure level, or adjust efficiency at the tube opening portion. Likewise, an opening portion 150′ corresponding to an opening end and an attenuation material 150a′ as well as an opening portion 150″ corresponding to an opening end and an attenuation portion 150a″ are provided at given positions.

Also, the back housing 110B is provided with a port 160 allowed to function as a bass reflex port and also as a tube opening end OE by way of the second sound channel 140.

In the configuration as above, various types of urethane or various types of non-woven cloth are available as the respective attenuation materials.

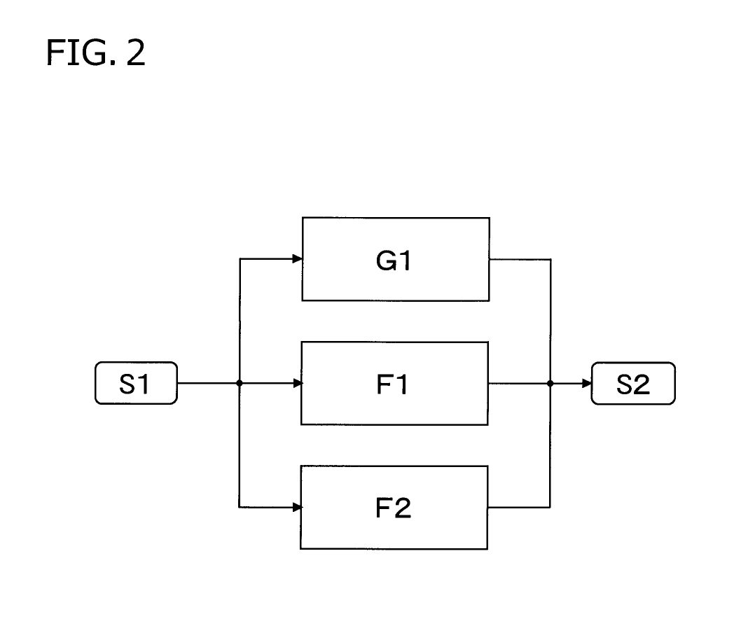

FIG. 2 is a functional block diagram used to describe a function and an effect obtained by the configuration of the earphone 100 as described above, that is, generation and combining of reflected sound components and a mechanism of eliminating the occlusion effect in an external auditory canal. FIG. 3C is a view used to describe the earphone 100 of this embodiment in terms of tube resonation.

### Operation of the Embodiment

In the configuration as described above, sounds are generated as the vibration plate vibrates according to an electric signal supplied to the driver unit 101.

A sound S1 from the front of the driver unit 101 reaches the ear drum ED from the external auditory canal Ex by passing through the attenuation material 130a functioning as a first filter portion F1 by way of the first sound channel 130.

In this instance, a peak frequency range (in the vicinity of 6 kHz) generated by the occlusion effect in an external auditory canal is attenuated by the attenuation material 130a as the first filter portion F1 (see FIG. 2).

At the same time, by allowing the opening portion 150 to function as the opening end OE of the external auditory canal Ex as is shown in FIG. 3C, the frequency range (in the vicinity of 3 kHz) that is otherwise attenuated by the occlusion effect in an external auditory canal is adjusted so as not to be attenuated by the opening portion 150 corresponding to the opening end and the attenuation material 150a as a second filter portion F2 (see FIG. 2). In this case, by selecting a material and a thickness of the attenuation material 150a, it becomes possible to maintain a frequency range to be attenuated or not to be attenuated and an amount of attenuation in a desired state.

Further, the port 160 by way of the first sound channel 130 and the second sound channel 140 can function as the opening end OE of the external auditory canal Ex shown in FIG. 3c. In this case, because the opening portions 150, 150′ and 150″ and the port 160 each corresponding to the opening end have different lengths as a tube, the occlusion effect in an external auditory canal can be canceled out effectively.

Further, a sound from behind the driver unit 101 turns to a sound having a predetermined time lag with respect to a direct sound by passing through the second sound channel 140 and the attenuation material 140a together as a reflection component generating portion GI (see FIG. 2). The sound now in a state equal to a spatial reflected sound (for example, a reflected sound or a reverberating sound) is then combined with a sound in the first sound channel 130 and outputted. In this case, by selecting a diameter and a length of the second sound channel 140, it becomes possible to generate vibrations comparable to a spatial reflected sound with a desired time lag. Further, in this case, by selecting a material and a thickness of the attenuation material 140a, it becomes possible to maintain an amount of attenuation in a desired state.

A sound coming by way of the second sound channel 140 is combined with a direct sound immediately before (upstream of) the attenuation material 130a in FIG. 1. It should be appreciated, however, that the invention is not limited to this configuration. A sound coming by way of the second sound channel 140 may be combined with a direct sound in a downstream part of the attenuation material 130a.

As has been described, when a sound S1 generated in the driver unit 101 is outputted from the first sound channel 130 toward the external auditory canal as a direct sound, a sound in a delayed state, which is a sound generated in the driver unit 101 and transmitted through the second sound channel 140 as a channel different from the first sound channel 130, is combined with a sound in the first sound channel 130. Consequently, the sound S1 turns to a sound S2 in a state in which a spatial reflected sound is artificially added to a direct sound from the driver unit 101. It thus becomes possible to achieve out-of-head sound localization by the earphone alone by correcting in-head localization of image sounds without requiring a signal processing circuit.

Also, by providing the second sound channel 140 with the attenuation material 140a that makes an adjustment to match a phase and a sound pressure level of a reflected sound generated by reflection on a spatial boundary, it becomes possible to generate a sound equivalent to a spatial reflected sound in a suitable phase at a suitable sound pressure level.

By making an adjustment in such a manner that a variance of the frequency characteristic caused by the occlusion effect in an external auditory canal is eliminated by providing the attenuation material 130a to the first sound channel 130, it becomes possible to achieve the out-of-head sound localization by suppressing the occlusion effect in an external auditory canal and correcting the in-head sound localization by the earphone alone without requiring a signal processing circuit.

Also, by providing the opening portion 150 corresponding to the tube opening end OE at a given position in the vicinity of the first sound channel 130, a variance of the frequency characteristic caused by the occlusion effect in an external auditory canal can be reduced. It thus becomes possible to achieve the out-of-head sound localization by suppressing the occlusion effect in an external auditory canal by the earphone alone without requiring a signal processing circuit. Likewise, by providing the opening portion 150′ corresponding to the opening end and the opening portion 150″ corresponding to the opening end, it also becomes possible to achieve the out-of-head sound localization by suppressing the occlusion effect in an external auditory canal by the earphone alone in the same manner as above.

Also, as has been described, by providing not only the opening portion 150 corresponding to the tube opening end OE at a given position in the vicinity of the first sound channel 130 but also the attenuation material 150a, a variance of the frequency characteristic caused by the occlusion effect in an external auditory canal can be reduced. It thus becomes possible to achieve the out-of-head sound localization by suppressing the occlusion effect in an external auditory canal by the earphone alone without requiring a signal processing circuit. Likewise, by providing the opening portion 150′ corresponding to the opening end and the attenuation material 150a′ as well as the opening portion 150″ corresponding to the opening end and the attenuation material 150a″, a variance of the frequency characteristic caused by the occlusion effect in an external auditory canal can be reduced, too. It thus becomes possible to achieve the out-of-head sound localization by suppressing the occlusion effect in an external auditory canal by the earphone alone without requiring a signal processing circuit in the same manner as above.

### Modification 1

It should be understood that the respective configurations shown in FIG. 1 merely represent a specific example of the embodiment and various modifications are possible.

For example, it is possible to provide a plurality of second sound channels as the second sound channel 140 to generate a sound equivalent to a plurality of spatial reflected sounds each having a different time lag.

In this case, a time lag can be extended or shortened and magnitude of a delay can be increased or decreased by selectively switching a plurality of the second sound channels to open and close using shutters or the like, so that a user can select a desired reflected sound, such as reverberation in a small hall, reverberation in a large hall, and reverberation in a concert venue.

### Modification 2

By forming the attenuation material 130a exchangeable by a user, the user becomes free to make an adjustment regarding to which extent the occlusion effect in an external auditory canal is eliminated (for example, adjustment of an amount of attenuation and a frequency) and a selection regarding to which extent the out-of-head sound localization is widened or narrowed. Likewise, by also forming the other attenuation materials exchangeable by the user, the user becomes free to make an adjustment regarding to which extent the occlusion effect in an external auditory canal is eliminated and a selection regarding to which extent the out-of-head sound localization is widened or narrowed.

### Modification 3

By providing an iris mechanism capable of adjusting a hole diameter like an iris diaphragm to the second sound channel 140 at some midpoint or to the opening portion 150 corresponding to the opening end, it becomes possible to adjust a level of a spatial reflected sound and an extent to which the occlusion effect in an external auditory canal is suppressed. The user thus becomes able to use the headphone in a desired condition.

### DESCRIPTION OF THE REFERENCE NUMBER AND SIGNS

100: earphone

101: driver unit

101a: attenuation material

110M: mesh

110F: front housing

110B: back housing

110C: cable housing

120: ear piece

130: first sound channel

130a: attenuation material

140: second sound channel

140a: attenuation material

150, 150′, and 150″: opening portion corresponding to opening end

150a, 150a′, and 150a″: attenuation material

160: port

CE: closing end

ED: ear drum

Ex: external auditory canal

F1: first filter portion

F2: second filter portion

G1: reflected sound generation portion

OE: opening end

1. an earphone comprising:
a driver unit that converts an electrical signal inputted therein to a sound;
a first sound channel through which a sound generated in the driver unit on a sound releasing side in front of the driver unit is introduced into an external auditory canal; and
a second sound channel through which a sound generated in the driver unit is transmitted by way of a channel different from the first sound channel to combine the transmitted sound with the sound in the first sound channel.

2. The earphone according to claim 1, wherein:
the second sound channel is where a sound equivalent to a reflected sound generated by reflection on a spatial boundary is generated.

3. The earphone according to claim 2, wherein:
the second sound channel is provided with an attenuation material that adjusts a phase to match an arrival time difference of the reflected sound generated by reflection on the spatial boundary.

4. The earphone according to claim 2, wherein;
the second sound channel is provided with an attenuation material that makes an adjustment to match a sound pressure level of the reflected sound generated by reflection on the spatial boundary.

5. The earphone according to claim 1, wherein:
the first sound channel is provided with an attenuation material having an attenuation characteristic selected so as to eliminate a variance of a frequency characteristic caused by an occlusion effect in an external auditory canal.

6. The earphone according to claim 1, wherein:
a plurality of opening portions each corresponding to an opening end are provided to the driver unit in each of a front surface and a rear surface to eliminate a variance of a frequency characteristic caused by an occlusion effect in an external auditory canal.

7. The earphone according to claim 6, wherein:
the opening portion is provided with an attenuation material having an attenuation characteristic selected so as to eliminate a variance of the frequency characteristic caused by the occlusion effect in an external auditory canal.
